(19) United States
(12) Patent Application Publication
(10) Pub. No.: US 2004/0169745 A1
(43) Pub. Date: Sep. 2, 2004

(54) Method and device for recognizing or displaying image defects in image recording systems

(76) Inventor: Matthias Franz, Tuebingen (DE)

Correspondence Address: KENYON & KENYON, ONE BROADWAY, NEW YORK, NY, 10004, US

(21) Appl. No.: 10/472,319

(22) PCT Filed: Nov. 8, 2002
(86) PCT No.: PCT/DE02/04131

(30) Foreign Application Priority Data
Jan. 17, 2002 (DE) 102015201

(51) Int. Cl. H04N 5/217; H04N 5/238

(52) U.S. Cl. 348/241; 348/364; 348/254

(57) ABSTRACT

A method and an apparatus for detecting and indicating faults in image acquisition systems is proposed, a self-diagnosis function being provided which detects and classifies image faults. The image acquisition system outputs fault signals which indicate the presence of the image fault and the type of image fault.

### BACKGROUND OF THE INVENTION

The invention relates to a method and an apparatus for detecting and indicating image faults in image acquisition systems, in particular in a motor vehicle.

Self-diagnosis functions for image acquisition systems, in particular for cameras for video monitoring systems, which refer to the detection of failures of electronic components by using special circuit assemblages, or which detect a failure of the image sensor itself by comparison to a stored reference image, are known (cf. for example JP 11-027704 A). In applications in which subsequent actions are derived on the basis of the ascertained image, it is necessary to detect not only failure of the image sensor, but also other fault circumstances that might result in a defective image and therefore possibly in erroneous conclusions on the basis of that image. Examples for such applications is the automotive sector, in which, in conjunction with video-based driver assistance systems, suggestions for a variety of actions derived from video images are known, from warnings upon leaving a lane to automatic collision-avoidance braking.

### ADVANTAGES OF THE INVENTION

Advantageously, the image acquisition system indicates an image fault by way of a fault code signal. On the basis of this fault code signal, the image viewer or the downstream evaluating system can decide whether the transferred image is suitable for further processing.

It is further advantageous that expanded detection capabilities are made available. A large number of image fault classes are detected, going well beyond mere detection of the failure of a hardware component. The result is to effectively prevent serious failures of the overall system from occurring as a result of image faults. The detected faults can be classified, and the fault class can be reported in the fault code signal.

In particularly advantageous fashion, the detection of image faults is accomplished solely on the basis of analysis of the input image of the image sensor (e.g. of a video camera), using statistical and image-processing methods. It is thereby possible to effectively detect and classify a large number of image faults. It is particularly advantageous that exposure faults, image noise, masking of the image sensor, and unsharpness in the image can be detected and correspondingly indicated.

Use of the image detection and indication system for video-based driver assistance systems in motor vehicles is particularly advantageous. This makes it possible for the video-based driver assistance system to react appropriately to the type of image fault detected.

It is advantageous in this context that the image acquisition system itself, without additional components, detects and classifies such image faults and transmits them to downstream image processing modules.

Further advantages are evident from the description below of exemplified embodiments, and from the dependent claims.

### DRAWING

The invention will be explained in more detail below with reference to the embodiments depicted in the drawings. The single Figure shows an image acquisition system, in particular a camera, having an image-based self-diagnosis function.

### DESCRIPTION OF EXEMPLARY EMBODIMENTS

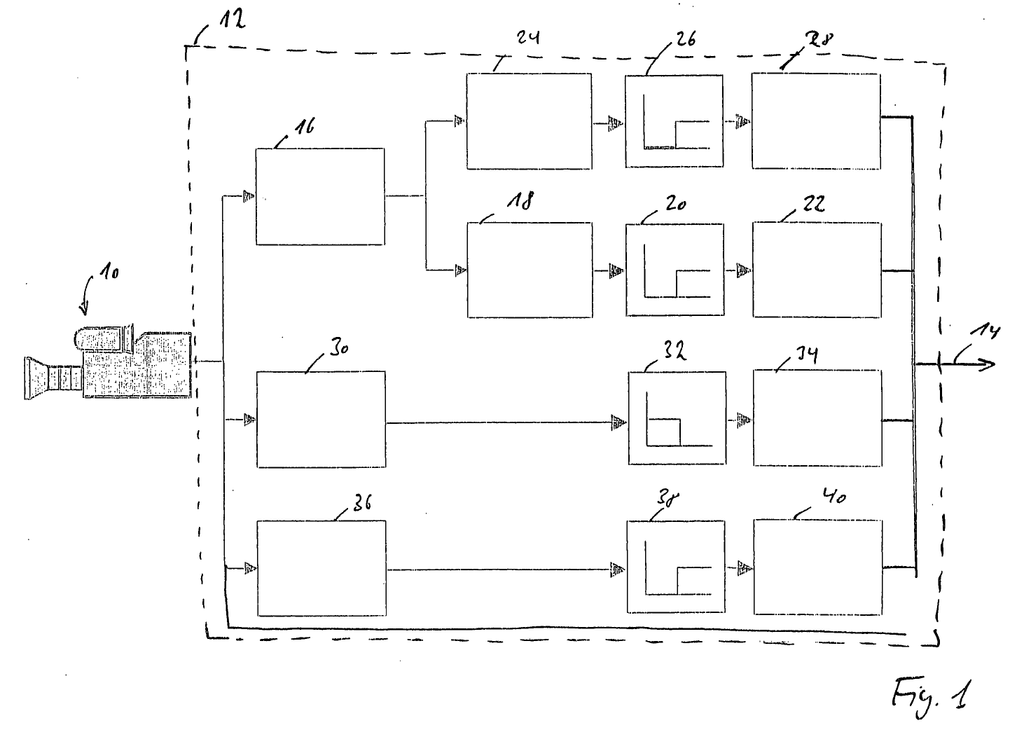

FIG. 1 depicts an image acquisition system having an image sensor 10, for example a CCD or CMOS camera, which sends images to an evaluation unit 12. This evaluation unit 12 encompasses modules for self-diagnosis of image acquisition system 10. The faults that are ascertained are then transferred via interface 14, as a fault code signal (electrically, digitally, acoustically, and/or visually), to downstream systems for indication, information, and/or storage. These downstream systems evaluate the fault code and react accordingly, e.g. by not evaluating the image that is supplied, by indicating a malfunction, or by initiating substitute actions (using only the information that can be derived in fault-free fashion from the defective image).

Evaluation unit 12 encompasses modules that, on the basis of analysis of the input images of the image sensor, detect and classify image faults using statistical and/or image-processing methods. “Image faults” are to be understood here as all impairments of the image quality of the camera images, especially those which can impair the function of downstream processing systems (e.g. lane alert system, anti-collision systems, etc.). Under- and overexposure, severe image noise, masking of the image or a portion of the image, or unsharpness in the optical image are understood in particular as image faults. These image faults are detected on the basis of the procedure described below by way of example, and corresponding fault codes characterizing the respective image faults are generated and transmitted.

In the preferred exemplified embodiment, evaluation unit 12 is made up of a computer in which programs are executed that carry out the procedure described below for fault detection and fault code generation and output. All the fault detection actions mentioned, or only a portion thereof in any combination, or in individual cases even only one of the fault detection actions, is/are used depending on the exemplified embodiment.

For detection and identification of an exposure fault, a histogram of the image acquired by image sensor 10 is prepared in module 16, the frequencies of occurrence of the grayscale values of the image being plotted against the possible grayscale values. If the histogram shows an accumulation of grayscale values at the lower or upper end of the value range, under- or overexposure, respectively, is then present. This evaluation takes place in module 18 where, for example, a check is made as to whether the frequencies of occurrence of grayscale values exceed certain limit values at the lower or upper end. Another possibility is to determine an average grayscale value and to detect under- or overexposure by comparison to defined limit values. If under- or overexposure of the image is indicated as a result of this evaluation, a corresponding fault code signal is generated in module 22 and outputted.

A further fault condition that is derived from the histogram created in module 16 is the masking fault. If the camera is masked by an opaque object directly in front of the lens, e.g. by a cover or a hand held in front, this results in a considerable contrast loss, or a relatively homogeneous grayscale value distribution, in the sensor image. The image contrast can be measured, for example, by way of the standard deviation or the entropy of the histogram data. This is accomplished in module 24, while if a fault is detected, a fault signal with a corresponding fault code is generated in module 28 and outputted.

In addition to this type of masking detection, in stereo cameras masking of one side of the stereo camera is ascertained by comparison of the acquired images, e.g. by comparing the histograms of the two images. Masking of one of two cameras in the context of a stereo camera is also detected using other methods, for example by direct comparison of the pixels, etc. Details are described in a simultaneously submitted patent application of the same applicant. Here again, a predetermined number of fault detections must be present in order to generate a fault signal. Another fault condition that is classified as a masking fault is a brief, partial masking of the camera image, for example as a windshield wiper passes in front of the image sensor. This masking situation is ascertained by way of a model that estimates, on the basis of the last image or at least two previous images, the exposure situation of the next image. If the actual exposure situation is different from the predicted one by a predetermined amount, a partial, dynamic masking of the image is assumed. Here a fault code signal is generated immediately because the masking is only brief.

A further fault class concerns image noise. For that purpose, in module 30 the correlation of the grayscale values of adjacent pixels is evaluated. In natural images, the grayscale values of adjacent pixels are strongly correlated with one another. If there is noise in the image from the image sensor, this spatial correlation is lost. To detect this fault, the spatial correlation of the pixels in a preselected image region is therefore determined by calculating a correlation function. The result shows either the strong correlation of grayscale values in natural images, or the absence of correlation of grayscale values in a noise situation. If the spatial correlation is absent, an image fault is assumed to exist. For fault detection, the correlation function is compared to a limit value that identifies a permissible magnitude of the correlation function. If an image fault of this kind is detected, the image code signal is generated in module 34 and outputted. In the preferred exemplified embodiment, a fault code signal for the noise fault is generated only for a specific number of fault detection(s), since a large number of detected noise faults suggests other faults (not image faults) (threshold value section 32).

A further improvement can be achieved if the correlation is calculated in time-related fashion, i.e. on the basis of successive images. This additionally permits the detection of further faults such as, for example, camera synchronization problems. In this case the correlation function of individual pixels is ascertained in a specific image region of successive images, and processed accordingly.

A further fault condition, unsharpness, is ascertained in module 36. If an unsharp image is detected, a fault is then ascertained. A fault signal having the “Unsharpness” fault code is then generated in module 40 and outputted. The unsharpness itself is obtained, for example, by a contrast spectrum or from the Fourier spectrum or from the autocorrelation function. Details concerning unsharpness measurement are described in a simultaneously submitted patent application of the same applicant.

Further faults detectable in the image are, for example, cracks in the glass of the windshield in front of the image sensor (e.g. derived from unsharpness), adhesion faults in the substrate between lens and glass, or, as mentioned above, partial masking resulting from opaque objects such as e.g. stickers or dirt.

Depending on the embodiment, the modules presented above are operated in parallel or in any desired combination.

In the event that a specific fault is present in the image of the image sensor, a fault signal having a specific fault code indicating the specific image fault is therefore outputted. In the event of excessive or insufficient illumination of the scene imaged by the sensor, masking or defocusing of the objective, or presentation of a noisy image, for example, the corresponding fault codes are ascertained and outputted.

In a preferred exemplified embodiment, the faults indicated above, in particular regarding masking, exposure faults, and/or unsharpness, are not indicated until an image fault occurs with a defined frequency of occurrence, or a defined number of fault detections (symbolized by thresholds 20, 26, 38) has been ascertained. This prevents excessive fault reporting.

In other embodiment, each detected fault is indicated, especially if downstream systems have extensive fault evaluation and reaction actions associated with them.

In an exemplified embodiment, in addition to the type of fault the extent of the fault, i.e. its severity, is also detected and transmitted. Taking the example of unsharpness, this is accomplished e.g. on the basis of the average slope of the contrast spectrum; for noise, on the basis of the magnitude of the correlation function. The severity of the fault is either coded in the fault signal or transferred additionally as a value. This kind of information allows downstream systems to control their reaction as a function of the fault severity.

The procedure described above is not limited solely to the use of image acquisition systems in motor vehicles but is used wherever, in conjunction with image acquisition systems, a knowledge of the type of fault, and the informing of downstream systems or observers regarding the type of fault, play an essential role.

What is claimed is:

1. A method for detecting and indicating image faults in image acquisition (recording) systems, an image being sensed by an image sensor and conveyed to an evaluation unit, wherein when an image fault is present, the evaluation unit delivers a fault signal that indicates the type of image fault.

2. The method as recited in claim 1, wherein when an image fault is present, the evaluation unit furthermore delivers a fault signal which indicates the magnitude of the image fault.

3. The method as recited in one of the preceding claims, wherein fault detection and fault classification are performed solely on the basis of the image transmitted by the image sensor.

4. The method as recited in one of the preceding claims, wherein the following image faults are indicated: “under- and overexposure,” “masking,” “noise,” and/or “unsharp image.”

5. The method as recited in one of the preceding claims, wherein indication of the image fault is accomplished by way of an electrical, preferably digital, fault code signal and/or corresponding visual and/or acoustic signals.

6. The method as recited in one of the preceding claims, wherein an exposure fault is ascertained on the basis of the histogram of the grayscale values.

7. The method as recited in one of the preceding claims, wherein masking is deduced from the histogram of the grayscale values of the sensor image.

8. The method as recited in one of the preceding claims, wherein a noise fault is determined by way of the spatial correlation of pixels of the image.

9. The method as recited in one of the preceding claims, wherein an unsharpness measurement is ascertained by way of a contrast spectrum, a Fourier spectrum, or an autocorrelation function.

10. The method as recited in one of the preceding claims, wherein the image acquisition system is used in conjunction with a driver assistance system for motor vehicles, the ascertained fault signal being transmitted to downstream control systems for evaluation.

11. An apparatus for detecting and indicating image faults in image acquisition (recording) systems, comprising an image sensor that generates an image, an evaluation unit that evaluates the image and generates at least one fault signal, wherein the evaluation unit has means which generate the fault signal when an image fault is present, the fault signal indicating the type of image fault.
